(19) United States
(12) Patent Application Publication
(10) Pub. No.: US 2025/0274178 A1
(43) Pub. Date: Aug. 28, 2025

(54) BEAMFORMING SYSTEM AND METHOD FOR WIRELESS SYSTEMS

(71) Applicant: Airgain, Inc., San Diego, CA (US)

(72) Inventors: Cheng-Yuan Chin, San Diego, CA (US); Devis Iellici, Cambridge (GB); Shenjie Miao, San Diego, CA (US); Yi Wang, San Diego, CA (US); Ali Sadri, San Diego, CA (US)

(21) Appl. No.: 19/056,119

(22) Filed: Feb. 18, 2025

Related U.S. Application Data
(60) Provisional application No. 63/557,001, filed on Feb. 23, 2024.

(51) Int. Cl. H04B 7/06; H04B 7/0413; H04B 17/318; H04L 41/16

(52) U.S. Cl. CPC H04B 7/0617; H04B 7/0413; H04B 17/328; H04L 41/16

(57) ABSTRACT

A wireless system comprises a modem and an RF front end coupled to an analog beamforming network. A processor executes a daemon which acquires predefined parameters from the modem in response to different beams generated by the beamforming network. A local machine learning (ML) processor is configured to receive first data from the daemon including the predefined parameters and to generate second data using the first data for optimally setting each of the different beams. The local ML processor is configured to select the best beam based on performance metrics of the wireless system. The local ML processor is configured to communicate the second data to a remote ML processor and to receive third data from the remote ML processor. The local ML processor is configured to generate the second data using the first data and the third data for optimally setting each of the different beams.

This application claims the benefit of U.S. Provisional Application No. 63/557,001, filed Feb. 23, 2024, the entire content of which is hereby incorporated by reference.

### SUMMARY

Various embodiments are directed to a system including a wireless system comprising a modem and a radio frequency (RF) front end, the wireless system coupled to an analog beamforming network comprising a plurality of antennas. A processor is configured to execute a daemon which, when executed, acquires one or more predefined parameters from the modem in response to each of a plurality of different beams generated by the beamforming network, the daemon configured to control the RF front end. A local machine learning (ML) processor is configured to receive first data from the daemon including the one or more predefined parameters associated with each of the different beams and to generate second data using the first data for optimally setting each of the different beams by the daemon and the RF front end. The local ML processor is configured to select one of the different beams based on one or more performance metrics of the wireless system. The local ML processor is also configured to communicate the second data to a remote ML processor and to receive third data from the remote ML processor. The local ML processor is further configured to generate the second data using the first data and the third data for optimally setting each of the different beams by the daemon and the RF front end. The second data and the third data can comprise one or more of beam direction data, beamforming weights, and configuration settings for radio frequency hardware of the wireless system.

### BRIEF DESCRIPTION OF THE DRAWINGS

Throughout the specification reference is made to the appended drawings wherein:

FIG. 1 illustrates a communication system in accordance with any of the embodiments disclosed herein;

FIG. 2 illustrates a representative configuration of the wireless system shown in FIG. 1 in accordance with any of the embodiments disclosed herein;

FIG. 3 illustrates a representative configuration of a system including the wireless system shown in FIG. 2 in accordance with any of the embodiments disclosed herein;

FIG. 4 is a timing diagram of an automatic beamforming process in accordance with various embodiments;

FIG. 5 is a timing diagram of an automatic beamforming process in accordance with various embodiments;

FIG. 6 is a timing diagram of a manual beamforming process in accordance with various embodiments;

FIG. 7 is a timing diagram of an automatic beamforming process in accordance with various embodiments; and

FIG. 8 is a diagram showing operation of a remote ML processor in cooperation with a multiplicity of local ML processors in accordance with various embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments of the disclosure are directed to a beamforming apparatus and method for wireless systems. Some embodiments are directed to a communication system comprising an existing wireless system to which an analog beamforming network can be connected and controlled via a software daemon running in the operating system of the wireless system. The analog beamforming network can define a smart antenna which can be controlled by the daemon running in the operating system of the wireless system. Some embodiments are directed to a communication system comprising a wireless system coupled to an analog beamforming network which further includes a local machine learning (ML) processor configured to optimize operation of the communication system. In some embodiments, the local ML processor cooperates with a remote ML processor to further optimize operation of the communication system.

Embodiments of the disclosure are defined in the claims. However, below there is provided a non-exhaustive listing of non-limiting examples. Any one or more of the features of these examples may be combined with any one or more features of another example, embodiment, or aspect described herein.

Example Ex1. A system comprises a wireless system comprising a modem and a radio frequency (RF) front end, the wireless system coupled to an analog beamforming network comprising a plurality of antennas. A processor is configured to execute a daemon which, when executed, acquires one or more predefined parameters from the modem in response to each of a plurality of different beams generated by the beamforming network, the daemon configured to control the RF front end. A local machine learning (ML) processor is configured to receive first data from the daemon including the one or more predefined parameters associated with each of the different beams and to generate second data using the first data for optimally setting each of the different beams by the daemon and the RF front end. The local ML processor is configured to select one of the different beams based on one or more performance metrics of the wireless system. The local ML processor is also configured to communicate the second data to a remote ML processor and to receive third data from the remote ML processor. The local ML processor is further configured to generate the second data using the first data and the third data for optimally setting each of the different beams by the daemon and the RF front end.

Example Ex2. The system of Ex1, wherein the second data and the third data comprises one or more of beam direction data, beamforming weights, and configuration settings for radio frequency hardware of the wireless system.

Example Ex3. The system of Ex1, wherein the second data and the third data comprises maximum output power of the RF front end.

Example Ex4. The system of Ex1, wherein the local ML processor comprises a model trained using the first data received from the daemon and the third data received from the remote ML processor.

Example Ex5. The system of Ex1, wherein the remote ML processor comprises a model trained using the second data received from the local ML processor and other data accessible to the remote ML processor but not accessible to the local ML processor.

Example Ex6. The system of Ex5, wherein the other data comprises the second data acquired from a plurality of the wireless systems.

Example Ex7. The system of Ex5, wherein the other data comprises environmental factors impacting the wireless system.

Example Ex8. The system of Ex1, wherein the predefined parameters from the modem comprise one or more of RSRP, RSRQ, SINR, and MCS index.

Example Ex9. The system of Ex1, wherein the beamforming network supports a MIMO configuration.

Example Ex10. The system of Ex9, wherein the local ML processor is configured to optimally set each of the different beams for each MIMO port.

Example Ex11. The system of Ex1, wherein the wireless system is configured to operate in multiple frequency bands, and the local ML processor is configured to optimally set each of the different beams for each of the frequency bands.

Example Ex12. The system of Ex1, wherein each of the different beams is associated with a different radiation pattern.

Example Ex13. The system of Ex1, wherein the one or more performance metrics of the wireless system comprise one or both of data rate and signal reliability.

Example Ex14. The system of Ex1, wherein a communication protocol of the wireless system comprises one of a Wi-Fi, cellular, and Satcom protocol.

Example Ex15. The system of Ex1, wherein the wireless system comprises one of a 5G fixed wireless access (FWA) system, an ORAN-RU system, a PtP link, a PtMP link, and a Wi-Fi access point.

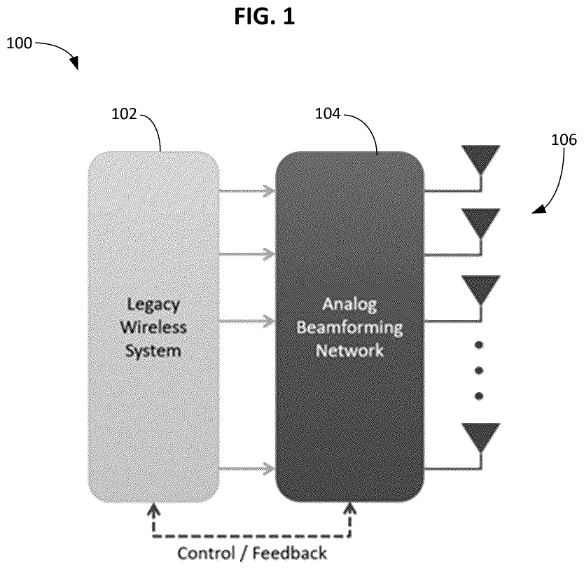

FIG. 1 illustrates a communication system 100 in accordance with any of the embodiments disclosed herein. The communication system 100 includes a wireless system 102, which may be an existing or legacy wireless system. The wireless system 102 is operably coupled to an analog beamforming network 104 which includes an array of antennas 106. The analog beamforming network 104 and antennas 106 can define a smart antenna, such as an adaptive array smart antenna or a switched beam smart antenna. The smart antenna 104 creates a different radiation pattern for every beam scan. In some embodiments, the smart antenna 104 can be a smart MIMO (multiple-input and multiple-output) antenna. Each MIMO port (e.g., MIMO_1 scan and MIMO_2 scan) can have an independent beamforming process. In other embodiments, the wireless system is configured to operate in multiple frequency bands, and the wireless system is configured to optimally set each of the different beams for each of the frequency bands.

The wireless system 102 can be, but is not limited to, a 5G FWA (Fixed Wireless Access) device, an ORAN-RU (Open Radio Access Network) device, a PtP (Point-to-Point) link, a PtMP (Point-to-Multipoint) link, or a Wi-Fi access point. The communication protocol of the wireless system 102 can be, but is not limited to, a Wi-Fi protocol, a cellular (e.g., LTE/5G/6G) protocol, or a Satcom protocol.

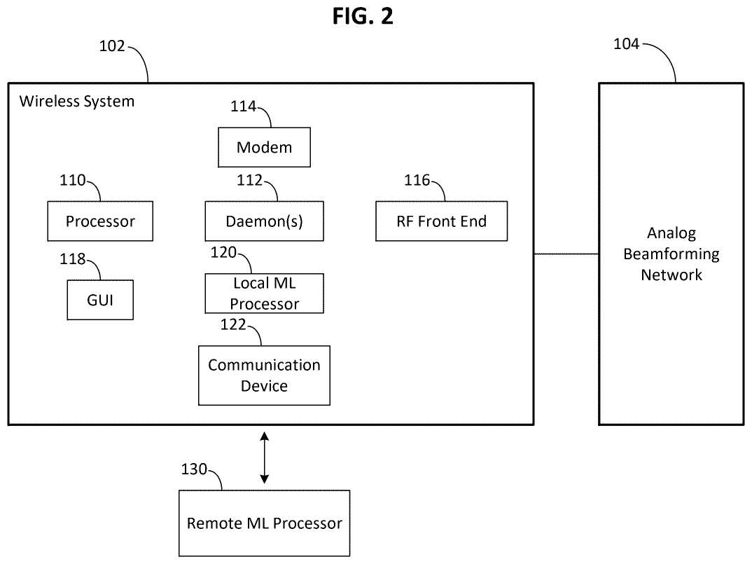

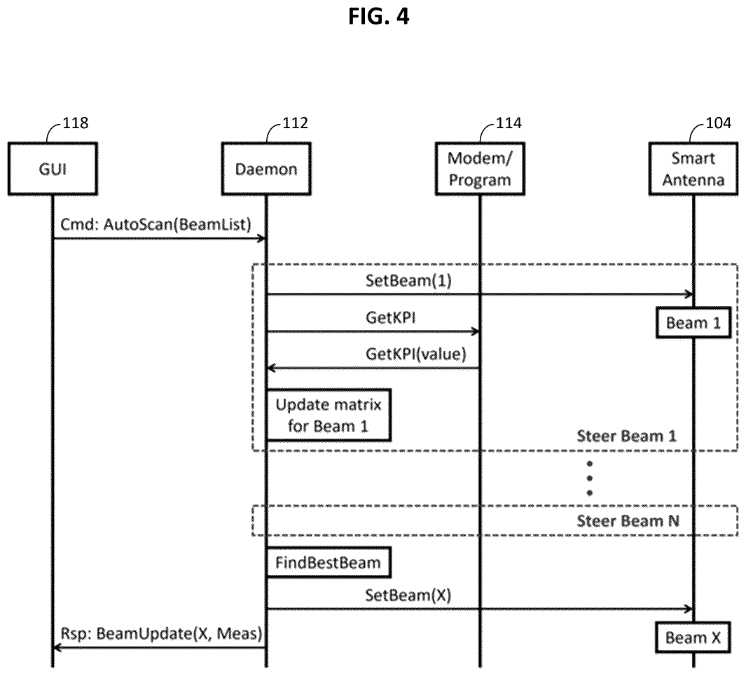

FIG. 2 illustrates a representative configuration of the wireless system 102 shown in FIG. 1 in accordance with various embodiments. The wireless system 102 shown in FIG. 2 includes a processor 110 configured to execute one or more software daemons 112 stored in a memory integral or coupled to the processor 110. A GUI 118 is configured to facilitate user interaction with the wireless system 102. The wireless system 102 also includes a modem 114 and a radio frequency (RF) front end 116. The RF front end 116 is coupled to the analog beamforming network 104 (e.g. smart antenna 104). The wireless system 102 further includes a local machine learning (ML) processor 120 which is configured to communicate and cooperate with a remote ML processor 130 in a manner described below via a communication device 122. The one or more daemons 112 implement various processes involving the modem 114, RF front-end 116, smart antenna 104, and local ML processor 120 in a manner shown in FIGS. 4-7.

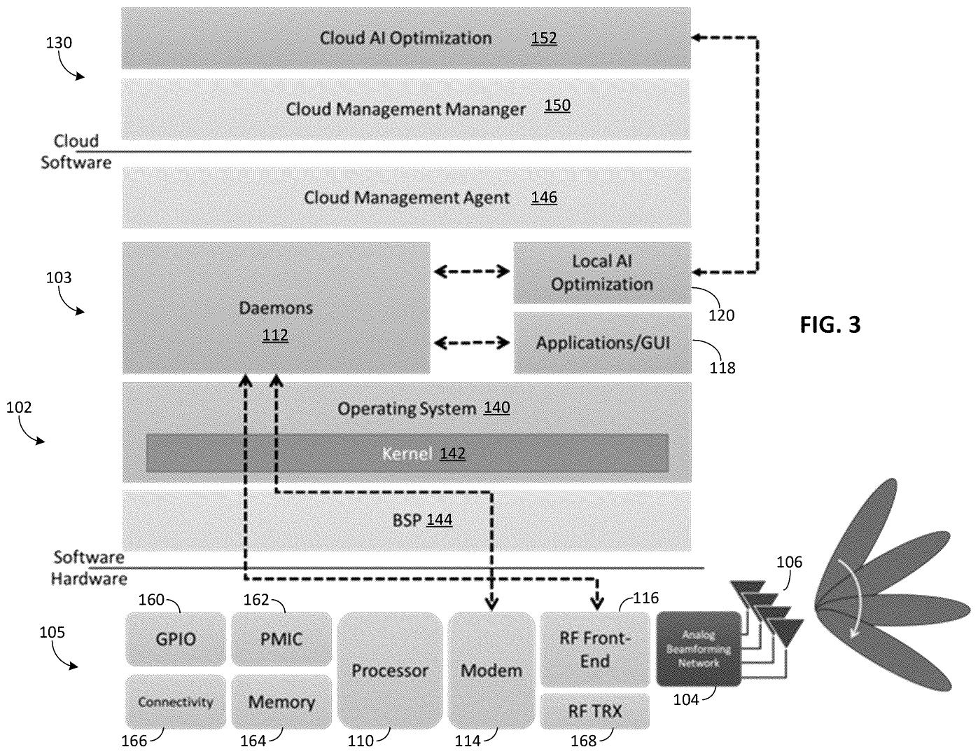

FIG. 3 illustrates a representative configuration of a system including the wireless system shown in FIG. 2 in accordance with any of the embodiments disclosed herein. FIG. 3 illustrates various hardware and software elements of a wireless system 102 and a remote ML processor 130. The wireless system 102 includes software elements 103 and hardware elements 105. The software elements 103 include a board support package (BSP) 144 and an operating system 140 comprising a kernel 142 that manages the hardware and software resources of the wireless system 102. The hardware elements 105, which are preferably mounted to a PCBA, include general-purpose I/O (GPIO) 160, a power management IC (PMIC) 162, a processor 110, memory 164, and connectivity elements 166 (e.g., a UART, SPI, I2C, PCIe, USB, M.2 elements). The hardware elements 105 also include a modem 114, an RF transceiver 168, an RF front-end 116, and an analog beamforming network 104 comprising an array of antennas 106. The analog beamforming network 104 and array of antennas 106 can define a smart antenna.

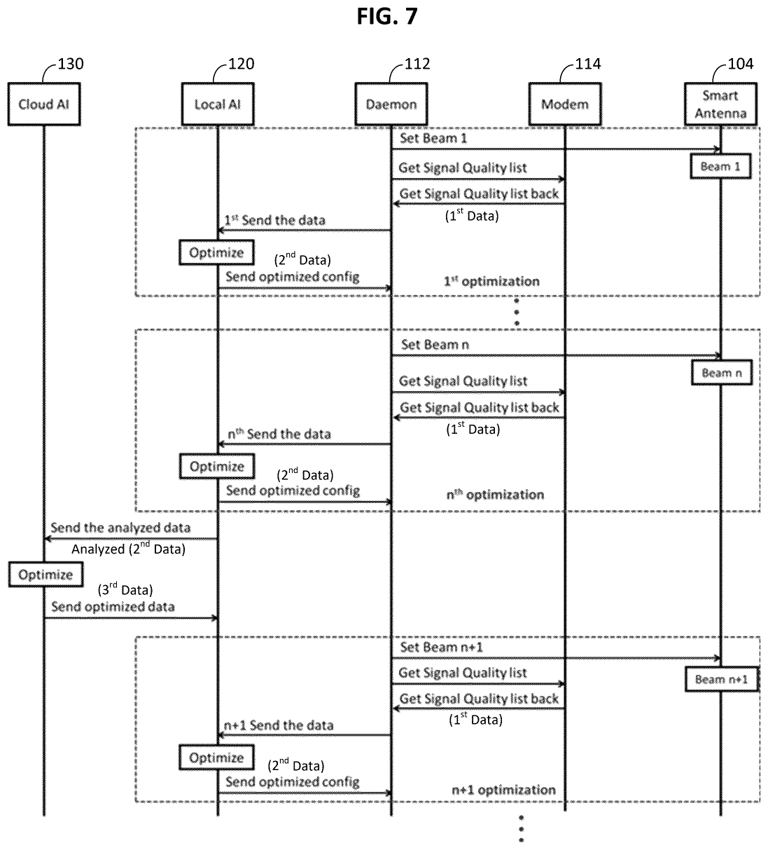

The processor 110 is configured to execute one or more daemons 112. A daemon 112 is configured to acquire certain predefined parameters from the modem 114 while analog beamforming is processed automatically or manually. A daemon 112 can be executed to configure and control the RF front-end 116 when setting different beams of the smart antenna 104 during an automatic or manual scanning process. A daemon 112 can be executed to interact with various applications and GUI 118. A daemon 112 can be executed to send and receive data (e.g., predefined parameters from the modem 114, smart antenna configuration data) to/from a local ML processor 120 configured to perform a local optimization process, such as that shown in FIG. 7 as discussed below.

According to a conventional wireless system design, a proprietary control channel is provided between the modem and smart antenna. Such a conventional design precludes the ability to pair the modem with a non-proprietary smart antenna. A wireless system of the present disclosure uses a daemon to control the analog beamforming process. The modem need not be aware of the analog beamforming activity. Embodiments of the disclosure advantageously enable the designer to use the smart antenna of their choice to pair with the modem, providing enhanced flexibility when implementing a wireless system.

With continued reference to FIG. 3, a remote ML processor 130 includes a cloud management manager 150 which is configured to communicate and cooperate with a cloud management agent 146 of the wireless system 102. The remote ML processor 130 receives optimized configuration data from the local ML processor 120 and additional data from other sources, including factors impacting the wireless system 102 and other wireless systems 102 as discussed below. Using these data, the remote ML processor 130 performs an optimization process 152 to produce optimized data, which is communicated to the local ML processor 120. The local ML processor 120 is configured to generate optimized data using the data received from the modem 114 and the optimized data received from the remote ML processor 130 for optimally setting each of the different beams by the daemon 112 and the RF front end 116.

FIG. 4 illustrates components of a wireless system 102 that cooperate to control a smart antenna 104 in accordance with various embodiments. In response to a user input, a GUI 118 is configured to issue a command to initiate an automatic scanning process. In general terms, the automatic scanning process involves scanning through all beam IDs on a beam list and collecting measurement data corresponding to each beam. An algorithm is implemented to determine and set the best beam, and the parameters of the best beam are reported back to GUI 118.

GUI 118 issues an auto scan command to daemon 112 which includes the beam list. For clarity of explanation, daemon 112 is shown as a single daemon, but can represent a number of different daemons. Daemon 112 communicates configuration parameters to the RF front end 116 to cause the smart antenna 104 to set Beam 1. Daemon 112 also communicates a command to the modem 114 to obtain one or more predefined parameters (e.g., a Key Performance Indicator—KPI) from the modem 114 for Beam 1. The predefined parameters obtained from the modem 114 can comprise one or more of RSRP (Reference Signal Received Power), RSRQ (Reference Signal Received Quality), SINR (Signal-to-Interference-plus-Noise Ratio), and MCS (Modulation Coding Scheme) index. A beam matrix is updated by daemon 112 which includes entries for beam ID (e.g., Beam 1), the one or more predefined parameters obtained from the modem 114 for Beam 1, and the steering angle of Beam 1.

The automatic scanning process continues for each of the remaining beam IDs on the beam list. For example, daemon 112 communicates configuration parameters to the RF front end 116 to cause the smart antenna 104 to set Beam 2. Daemon 112 also communicates a command to the modem 114 to obtain one or more predefined parameters from the modem 114 for Beam 2. The beam matrix is updated by daemon 112 to include entries for Beam 2, including the one or more predefined parameters obtained from the modem 114 for Beam 2 and the steering angle of Beam 2.

After performing the automatic scanning process for Beams 1-N, daemon 112 executes an algorithm to determine which of Beams 1-N generated the best performance parameter or parameters. In this illustrative example, daemon 112 determines that Beam X has produced the best performance parameter or parameters. Daemon 112 communicates configuration parameters to the RF front end 116 to cause the smart antenna 104 to set Beam X. Daemon 112 also communicates a response to GUI 118 that includes Beam X and its associated performance parameter or parameters.

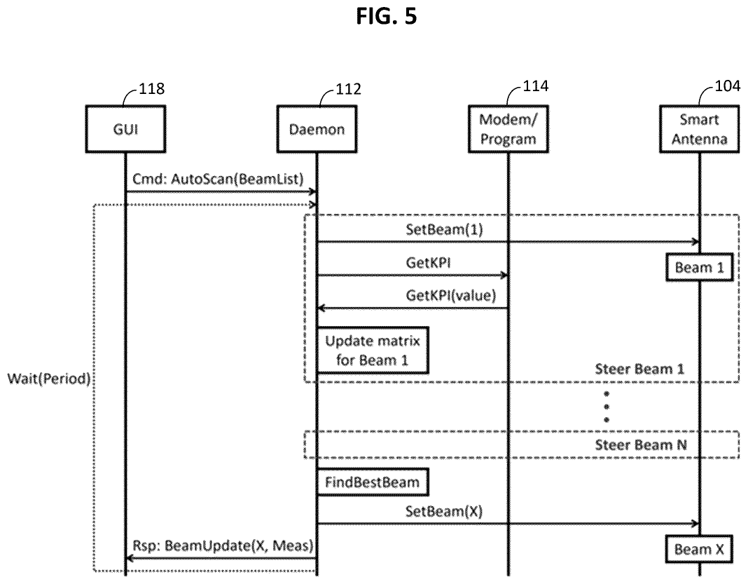

The automatic scanning process illustrated in FIG. 4 is initiated in response to a command generated by GUI 118 and concludes with daemon 112 communicating configuration parameters to the smart antenna 104 to set Beam X. In some embodiments, the automatic scanning process is continuously repeated such that the wireless system 102 repeatedly searches for the best beam over time. FIG. 5 illustrates an example embodiment of an infinite loop for implementing the automatic scanning process shown in FIG. 4. According to the embodiment shown in FIG. 5, after completing the automatic scanning process discussed above, daemon 112 initiates a wait period before repeating the automatic scanning process. The wait period can be several hours (e.g., 8-12 hours), a day or a week, for example. After expiration of the wait period, daemon 112 repeats the automatic scanning process to search for the best beam in the manner discussed above.

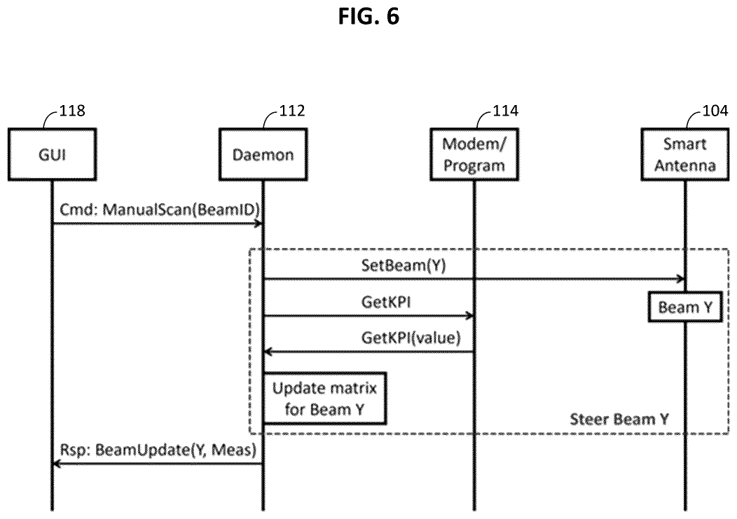

FIG. 6 illustrates a manual scanning process implemented by the wireless system 102 and smart antenna 104 in accordance with various embodiments. In response to a user input, GUI 118 is configured to issue a command to initiate a manual scanning process. The command issued by GUI 118 includes a beam ID (e.g., Beam Y). In response to the command issued by GUI 118, daemon 112 communicates configuration parameters to the RF front end 116 to cause the smart antenna 104 to set Beam Y. Daemon 112 also communicates a command to the modem 114 to obtain one or more predefined parameters from the modem 114 for Beam Y. A beam matrix is updated by daemon 112 which includes entries for beam ID (e.g., Beam Y), the one or more predefined parameters obtained from the modem 114 for Beam Y, and the steering angle of Beam Y. Daemon 112 also communicates a response to GUI 118 that includes Beam Y and its associated performance parameter or parameters.

FIG. 7 illustrates components of a wireless system 102 that cooperate to control a smart antenna 104 in accordance with various embodiments. The components of the wireless system 102 shown in FIG. 7 include daemon 112 executable by the processor 110 of the wireless system 102 (see FIG. 2), modem 114, and smart antenna 104. The wireless system 102 also includes a local ML processor 120, shown as Local AI (artificial intelligence) 120 for convenience. The local ML processor 120 communicates with a remote ML processor 130, shown as Cloud AI 130 for convenience, via a wireless communication device 122 (see FIG. 2).

According to FIG. 7, daemon 112, when executed by the processor 110, communicates configuration parameters to the RF front end 116 to cause the smart antenna 104 to set Beam 1. Daemon 112 also communicates a command to the modem 114 to obtain a signal quality list (e.g., first data) comprising one or more predefined parameters from the modem 114 for Beam 1. The predefined parameters obtained from the modem 114 can comprise one or more of RSRP, RSRQ, SINR, and MCS index. The daemon 112 communicates the predefined parameters obtained from the modem 114 for Beam 1 to the local ML processor 120. The local ML processor 120 comprises a model trained using the data received from the daemon 112. The model can be trained to dynamically optimize the beam direction, beamforming weights, and the configuration of the RF hardware (e.g., RF front end 116) to maximize performance metrics of the wireless system 102, such as data rate and signal reliability.

Using the first data received from the daemon 112, the local ML processor 120 performs an optimization process and generates second data for optimally setting Beam 1 by the daemon 112 and the RF front end 116. The second data can include one or more of beam direction data, beamforming weights, and configuration settings for radio frequency hardware of the wireless system 102 (e.g., maximum output power of the RF front end 116).

The optimization process discussed above for Beam 1 is repeated for each beam in the beam list (e.g., Beam n, Beam n+1). Following optimization of each beam in the beam list, the local ML processor 120 is configured to select one of the different beams based on one or more performance metrics of the wireless system 102. The performance metrics of the wireless system 102 can comprise, for example, one or both of data rate and signal reliability. In this illustrative example, the local ML processor 120 may determine that Beam n+1 has produced the best performance metric or metrics. Daemon 112 communicates configuration parameters optimized by the local ML processor 120 to the RF front end 116 to cause the smart antenna 104 to set Beam n+1 in this illustrative example.

As is further shown in FIG. 7, the local ML processor 120 communicates the optimized second data to the remote ML processor 130. The remote ML processor 130 comprises a model trained using the optimized second data received from the local ML processor 120 and other data accessible to the remote ML processor 130 but not accessible to the local ML processor 120. Such other data can include optimized second data received from a multiplicity of local ML processors 120 associated with other wireless systems 102. Such other data can also include environmental and other factors impacting the wireless system 102 and other wireless systems 102. Factors impacting the wireless system 102 and other wireless systems 102 can include, for example, current weather, temperature, humidity, altitude, location, changes in the surrounding (e.g., new building construction), and carrier setting changes.

Using these data, the remote ML processor 130 performs an optimization process to produce optimized third data, which is communicated to the local ML processor 120. The local ML processor 120 is further configured to generate optimized second data using the first data received from the modem 114 and the optimized third data received from the remote ML processor 130 for optimally setting each of the different beams by the daemon 112 and the RF front end 116.

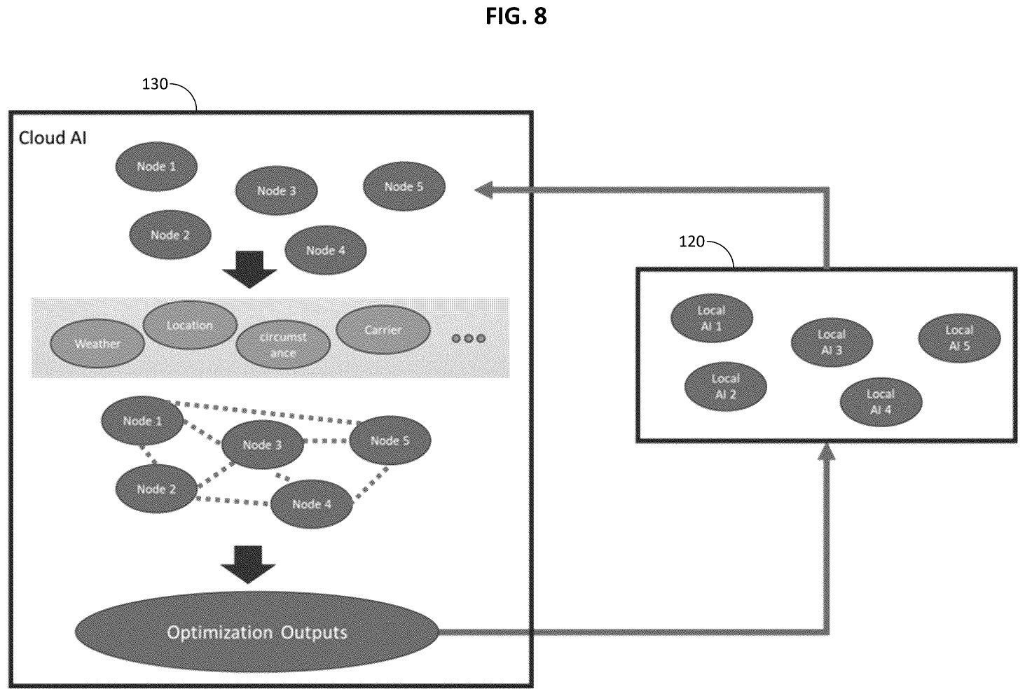

FIG. 8 is a diagram showing operation of a remote ML processor 130 in cooperation with a multiplicity of local ML processors 120 in accordance with various embodiments. The remote ML processor 130 can implement an artificial neural network, shown here as Cloud AI network. The Cloud AI network can include a model which can be trained using data received from the local ML processors 120 of a multiplicity of wireless systems 102, shown as Local AI 1 through Local AI 5 for illustrative purposes. Each of Local AI 1 through Local AI 5 is labeled as one node in the Cloud AI network. The results from each node are passed down to the next layer of the Cloud AI network. At this stage, the results are independent from each other. In this layer, the Cloud AI network introduces additional data associated with factors that impact the Local AIs, such as current weather, temperature, humidity, altitude, location, circumstances such as changes in the surrounding (e.g., new building construction), and carrier setting changes. These data are used by the Cloud AI network to model the complex relationship between the nodes and to produce optimization outputs which are communicated to the Local AIs. Each of the Local AIs uses optimized output received from the Cloud AI network to further optimize the setting of each of the different beams generated by the smart antenna 104 (see FIG. 7).

A wireless system that utilizes a Local AI and the Cloud AI network provides for enhanced operation of a wireless system. For example, there is a tradeoff between maximum output power of the RF front end and ambient temperature. It is not possible to change the maximum output power setting manually based on variations of the ambient temperature. Cooperation between the Local AI and the Cloud AI network provides the ability to adjust (e.g., optimize) the maximum output power on a daily basis for each individual wireless system.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed embodiments may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “various embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements. The phrases “at least one of,” “comprises at least one of,” and “one or more of” followed by a list refers to any one of the items in the list and any combination of two or more items in the list.

What is claimed is:

1. A system, comprising:
a wireless system comprising a modem and a radio frequency (RF) front end, the wireless system coupled to an analog beamforming network comprising a plurality of antennas;
a processor configured to execute a daemon which, when executed, acquires one or more predefined parameters from the modem in response to each of a plurality of different beams generated by the beamforming network, the daemon configured to control the RF front end; and
a local machine learning (ML) processor configured to receive first data from the daemon including the one or more predefined parameters associated with each of the different beams and to generate second data using the first data for optimally setting each of the different beams by the daemon, the local ML processor configured to select one of the different beams based on one or more performance metrics of the wireless system, the local ML processor also configured to communicate the second data to a remote ML processor and to receive third data from the remote ML processor;
wherein the local ML processor is further configured to generate the second data using the first data and the third data for optimally setting each of the different beams by the daemon.

2. The system of claim 1, wherein the second data and the third data comprises one or more of beam direction data, beamforming weights, and configuration settings for radio frequency hardware of the wireless system.

3. The system of claim 1, wherein the second data and the third data comprises maximum output power of the RF front end.

4. The system of claim 1, wherein the local ML processor comprises a model trained using the first data received from the daemon and the third data received from the remote ML processor.

5. The system of claim 1, wherein the remote ML processor comprises a model trained using the second data received from the local ML processor and other data accessible to the remote ML processor but not accessible to the local ML processor.

6. The system of claim 5, wherein the other data comprises the second data acquired from a plurality of the wireless systems.

7. The system of claim 5, wherein the other data comprises environmental factors impacting the wireless system.

8. The system of claim 1, wherein the predefined parameters from the modem comprise one or more of RSRP, RSRQ, SINR, and MCS index.

9. The system of claim 1, wherein the beamforming network supports a MIMO configuration.

10. The system of claim 9, wherein the local ML processor is configured to optimally set each of the different beams for each MIMO port.

11. The system of claim 1, wherein the wireless system is configured to operate in multiple frequency bands, and the local ML processor is configured to optimally set each of the different beams for each of the frequency bands.

12. The system of claim 1, wherein each of the different beams is associated with a different radiation pattern.

13. The system of claim 1, wherein the one or more performance metrics of the wireless system comprise one or both of data rate and signal reliability.

14. The system of claim 1, wherein a communication protocol of the wireless system comprises one of a Wi-Fi, cellular, and Satcom protocol.

15. The system of claim 1, wherein the wireless system comprises one of a 5G fixed wireless access (FWA) system, an ORAN-RU system, a PtP link, a PtMP link, and a Wi-Fi access point.

16. A method implemented by a wireless system comprising a modem and a radio frequency (RF) front end, the wireless system coupled to an analog beamforming network comprising a plurality of antennas;
executing, by a processor, a daemon which acquires one or more predefined parameters from the modem in response to each of a plurality of different beams generated by the beamforming network, the daemon controlling the RF front end; and
receiving, by a local machine learning (ML) processor, first data from the daemon including the one or more predefined parameters associated with each of the different beams and to generate second data using the first data for optimally setting each of the different beams by the daemon, the local ML processor selecting one of the different beams based on one or more performance metrics of the wireless system, the local ML processor communicating the second data to a remote ML processor and receiving third data from the remote ML processor, the local ML processor further generating the second data using the first data and the third data for optimally setting each of the different beams by the daemon.

17. The method of claim 16, wherein the second data and the third data comprises one or more of beam direction data, beamforming weights, and configuration settings for radio frequency hardware of the wireless system.

18. The method of claim 16, wherein the second data and the third data comprises maximum output power of the RF front end.

19. The method of claim 16, wherein the local ML processor comprises a model trained using the first data received from the daemon and the third data received from the remote ML processor.

20. The method of claim 16, wherein the beamforming network supports a MIMO configuration, and the local ML processor optimally sets each of the different beams for each MIMO port.
